(19) United States
(12) Patent Application Publication
(10) Pub. No.: US 2007/0133595 A1
(43) Pub. Date: Jun. 14, 2007

(54) Method for a wireless communication system and system for wireless communication

(76) Inventors: Yang-Ying Wu, Tainan (TW); Chih-Chiang Hsieh, Kaohsiung County (TW); Yung-Ting Lee, Taipei (TW); Hua-Chiang Yin, (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/391,828

(22) Filed: Mar. 29, 2006

(30) Foreign Application Priority Data
Dec. 8, 2005 (TW) 094143411

(51) Int. Cl. H04J 3/22; H04Q 7/00

(52) U.S. Cl. 370/465; 370/328

(57) ABSTRACT

A method for a wireless communication system and a system adapted for wireless communication are provided. The wireless communication system comprises a base station, a first terminal apparatus and a second terminal apparatus. The base station determines whether the first terminal apparatus and the second terminal apparatus conform to a condition. If yes, the base station transmits a datum to the first terminal apparatus, and requests the first terminal apparatus to transmit the datum to the second terminal apparatus.

### CROSS-REFERENCES TO RELATED APPLICATIONS

This application claims priority to Taiwan Patent Application No. 094143411 filed on Dec. 8, 2005.

### BACKGROUND OF THE INVENTION

1. Field of the Invention

The present invention relates to a method and a communication system applied in a wireless communication, specifically to a method and a communication system for transmitting a datum via a terminal apparatus.

2. Descriptions of the Related Art

In recent years, the market of wireless communication system is highly developed. Users rely on the communication products much more than ever before. Consequently, the demand of communication service quality for users is higher correspondingly.

FIG. 1 is a hierarchy diagram, which shows a prior wireless communication system. The communication system comprises a base station 10 and a plurality of subscriber station 101-104, communicating with each other utilizing the known communications protocol, for example, the IEEE 802.16 communication protocol. The base station 10 comprises a switched beam antenna SBA (not shown), which defines the range for communicating datum of the base station 10. The modulation methods, known so far, are classed as the binary phase shift keying BPSK, the quaternary phase shift keying QPSK, 16-quadrature amplitude modulation 16QAM and the 64-quadrature amplitude modulation 64QAM, etc. The quantity of transmitting data per unit time is 64QAM>16QAM>QPSK>BPSK. The prior base stations and the prior subscriber stations comprise those four types of modulation, and each of them could change different modulation separately as receiving data.

The Base station transmits a datum to each subscriber station 101-104 according to the modulation that they can accept. The acceptable modulation depends on each of the conditions of the subscriber stations at that time. In general, the subscriber station far away from the base station 10 or some obstructer in the midway would interfere the transmission therebetween, like subscriber station 104, the error rate of the datum of the subscriber station 104 becomes higher if the subscriber station uses the 64QAM modulation. To avoid this situation and to maintain a lower error rate, the subscriber station usually transmits the datum by the modulation, such as. QPSK or BPSK, etc. However, it will increase the time for the subscribers to receive the datum. Generally, the factors that affect transformation quality between subscriber stations and base station 10 depend on the distance, between the base station 10 and the subscriber station, and existence of obstructer therebetween. If a subscriber station is closer to the base station 10, like the subscriber station 101, then the chance of the signal decay or datum error due to disturbance is lower, and accordingly, the modulation with high transmitting quantity is used. On the contrary, if a subscriber station is far from the base station 10, like the subscriber station 104, then the chance of the signal decay or datum error due to disturbance is higher, and accordingly, the modulation with low transmitting quantity is used to avoid data transmission error. As shown in the drawing, three concentric circles are shown to represent different modulation, utilized by every terminal apparatuses as communicating. It should be noted that the distance is not the only factor to determine the modulation for use. As shown in FIG. 1, the subscriber station 101 receives datum with 64QAM modulation, the subscriber stations 102 and 103 receive datum with 16QAM, and the subscriber station 104 receives datum with QPSK modulation. In other words, the base station 10 can transmit datum to the subscriber station 101 by utilizing 64QAM modulation which transmits larger transmission data quantity, while to the subscriber stations 102 and 103 by utilizing 16QAM modulation, and to the subscriber station 104 by utilizing QPSK modulation with lower transmission data quantity.

The base station 10 must service every subscriber stations 101-104 even including the subscriber stations with inferior receiving quantity (such as the subscriber station 104 ). To reduce errors of the subscriber stations with inferior receive quantity, the base station 10 needs to consume more transmission resources, so the whole time to accomplish the transmission will become long. Consequently, a solution for decreasing the time for the base station to transmit data to every subscriber stations is essential.

### SUMMARY OF THE INVENTION

An object of this invention is to provide a method for a wireless communication system, which comprises a base station, a first terminal apparatus and a second terminal apparatus. The method comprises: determining whether the first terminal apparatus and the second terminal apparatus conforming to a condition; if yes, transmitting a datum to the first terminal apparatus; and requesting the first terminal apparatus transmitting the datum to the second terminal apparatus.

Another object of this invention is to provide a communication system which comprises a plurality of terminal apparatuses for receiving a datum, wherein the terminal apparatuses comprise a first terminal apparatus, a second terminal apparatus and a base station. The base station executes a transmission method, wherein the transmission method is utilized for transmitting the first datum to the first terminal apparatus when the base station desires to transmit the first datum to the second terminal apparatus, and the first terminal apparatus and the second terminal apparatus conform to a condition, and requesting the first terminal apparatus transmitting the first datum to the second terminal apparatus by the base station.

This invention provides a terminal apparatus which could transmit the datum to another terminal apparatus. When the terminal apparatus conforms to a condition, the base station executes one modulation which transmits larger data quantity for datum transmitting to the terminal apparatus, and the terminal apparatus transmits the datum to the another terminal apparatus for the purpose of decreasing the time of the datum transmitting from the base station to each of the terminal apparatuses.

Further objects and advantages for the present invention will become apparent from a consideration of the following description and drawings. The detailed technology and preferred embodiments implemented for the subject invention are described in the following paragraphs accompanying the appended drawings.

### BRIEF DESCRIPTION OF THE DRAWINGS

FIG. 1 illustrates a wireless communication system of the prior art;

FIG. 2A and FIG. 2B illustrate a first embodiment of the present invention;

FIG. 3 illustrates a calculation of an angle of a base station of the first embodiment of the present invention;

FIG. 4 is a flow chart in accordance with the first embodiment of the present invention;

FIG. 5A illustrates another prior art;

FIG. 5B illustrates a timing diagram in accordance with the prior art;

FIG. 5C illustrates a second embodiment of the present invention; and

FIG. 5D illustrates a timing diagram in accordance with the present invention.

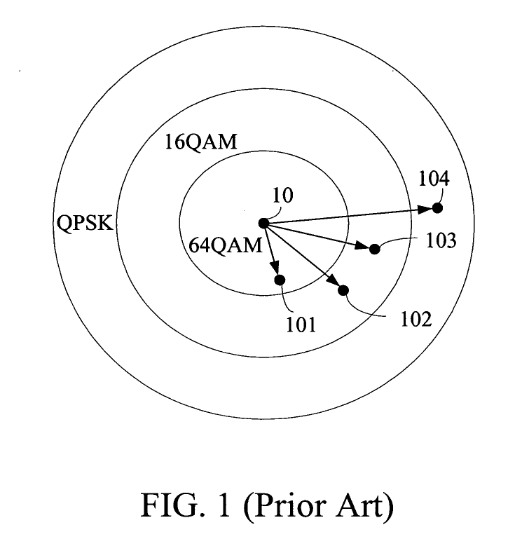

### DESCRIPTION OF THE PREFERRED EMBODIMENT

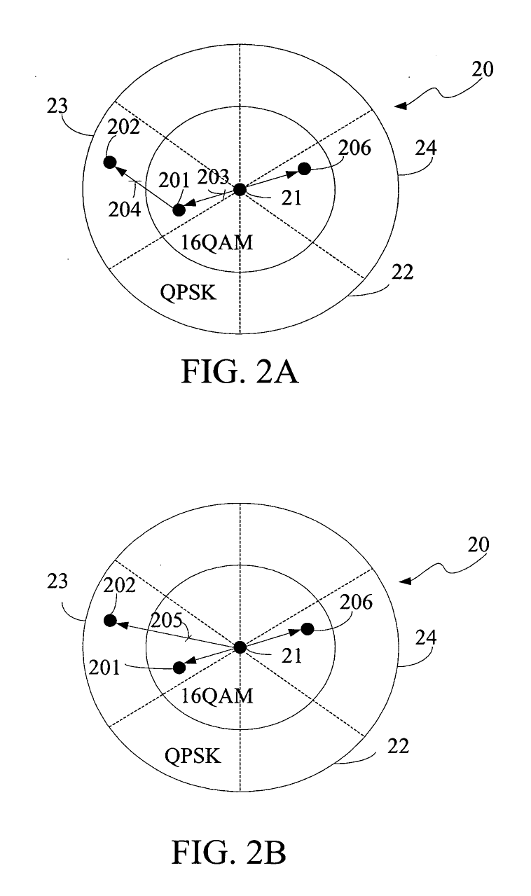

As shown in FIG. 2A, the first embodiment of this invention is a method and a communication system adapted for a wireless communication system 20. The system comprises a base station 21 and a plurality of terminal apparatuses. In the first embodiment, the terminal apparatuses comprise a first terminal apparatus 201, a second terminal apparatus 202 and at least a third terminal apparatus 206. The base station 21 is used to transmit a datum to the first terminal apparatus 201 and the second terminal apparatus 202. The base station 21 comprises a switched beam antenna (SBA, not shown), defining an area 22 for datum transmitting. As shown in this figure, SBA divides the area 22 into six area portions, called sectors generally. The first terminal apparatus 201 and the second terminal apparatus 202 are located in a first area 23, and the third terminal apparatus 206 is located in the second area 24. The area 22 is divided into two concentric circles to represent different modulations with which every terminal apparatus utilizes as the communication method of the present invention is executed. However, it does not mean that the distance is the only factor corresponding to the modulations. The first terminal apparatus 201 located in the inner concentric circle can utilize 16QAM which transmits bigger transmission data quantity than QPSK does, and the second terminal apparatus 202 located in the outer concentric circle can utilize QPSK to transmit datum.

The base station 21 determines whether the first terminal apparatus 201 and the second terminal apparatus 202 conform to a condition when the base station determines a datum is desired to transmit to the second terminal apparatus 202. One of the conditions is that the time the base station 21 transmits the datum to the first terminal apparatus 201 plus the time the first terminal apparatus 201 transmits the datum to the second terminal apparatus 202 shorter than the time the base station 21 transmits the datum to the second terminal apparatus 202, and the other conditions will be explained later. If the base station 21 determines the first terminal apparatus 201 and the second terminal apparatus conforms to the condition, then the base station 21 utilizes a first packet 203 of 16QAM modulation to transmit the datum to the first terminal apparatus 201, and the base station 21 requests the first terminal apparatus 201 to transmit the datum to the second terminal apparatus 202. The first terminal apparatus 21 utilizes a second packet 204 to transmit the datum to the second terminal apparatus 202 in response to the request.

It is noted that the base station 21, applying the method of the present invention, does not need to transmit the datum to the second terminal apparatus 202 by QPSK. Instead, it transmits the datum to the first terminal apparatus 201 by utilizing the modulation with bigger transmission data quantity via the first terminal apparatus 201 transmitting the datum to the second terminal apparatus 202. Meanwhile, the base station 21 could service the other terminal apparatuses located in other areas, for example, the third terminal apparatus 206 in FIG. 2A, to reduce the time of transmitting datum to the second terminal apparatus 202 directly by the base station 21 utilizing the method of the prior art. Thus, enhancing the efficiency of the base station 21 and reducing whole transmission time can thus be achieved.

The unit of the transmission data quantity mentioned above, i.e., modulation, is the bits per one symbol (bits/symbol). More specifically, 16QAM is 4 bits/symbol, QPSK is 2 bits/symbol. Hence, according to the example aforementioned, the quantity of the datum transmitted by the base station 21 to the first terminal apparatus 201 is almost twice as big as that to the second terminal apparatus 202.

Given the above, if the base station 21 determines that the first terminal apparatus 201 and the second terminal apparatus 202 do not conform to the condition, as shown in FIG. 2B, then the base station 21 transmits the datum to the second terminal apparatus 202 by a third packet 205 of OPSK modulation. That is, the first terminal apparatus 201 is not suitable to act as a relay when the first terminal apparatus 201 and the second terminal apparatus 202 do not conform to the condition. Consequently, the base station 21 would transmit the datum to the second terminal apparatus 202 used the same method of the prior art. After the base station 21 has transmitted the datum to the first terminal apparatus 201 and the second terminal apparatus 202 ,both located in the first area 23, then, the base station 21 sequentially service terminal apparatuses in the second area 24 or other areas, for example, the third terminal apparatus 206 as shown in FIG. 2B.

The transmission data quantity relates to the modulation of the terminal apparatus. If the first terminal apparatus 201 and the second terminal apparatus 202 use the same modulation, the base station 21 could transmit the datum to the second terminal apparatus 202 directly without transmitting the datum via the first terminal apparatus 201. If the base station 21 determines the first terminal apparatus 201 has a better modulation than the second terminal apparatus 202, for example, at that time the modulation of the first terminal apparatus 201 is 16QAM and that of the second terminal apparatus 202 is QPSK (this is the first condition among the other conditions of the aforementioned), the method of the present invention could be executed. If the base station 21 determines the first terminal apparatus 201 can feedback bigger power to the base station 21 than the second terminal apparatus 202 does (this is the second condition among the other conditions mentioned above), the method of the present invention could be utilized too.

For the second condition, the power reported to base station will reduce if distance from the apparatus to the base station 21 is long or something obstructing therebetween suppoesed each terminal apparatus is in the same situation. Hence, the base station 21 of present invention will take this power factor as a condition for judgement.

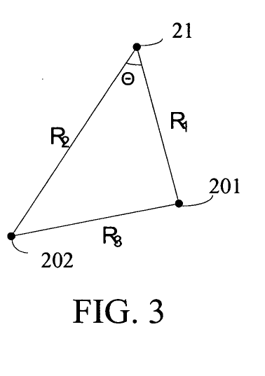

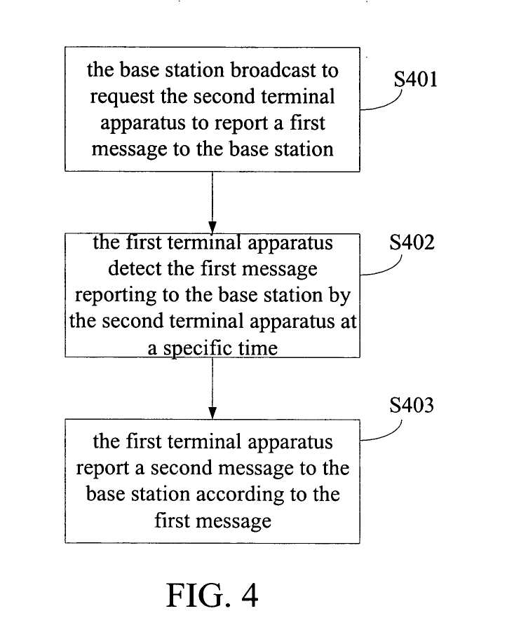

More specifically, first, the base station 21 transmits the datum to the second terminal apparatus 202 directly by the prior method if the distance between the second terminal apparatus 202 and the base station 21 is short. The reason of transmitting the datum directly by the base station 21 is the time thereof which is substantially the same with the time of transmitting the datum via the first terminal apparatus 201. Second, the SBA of the base station 21 can select different angles of fan-shaped areas when the areas are defined for transmitting data. The distance between the first terminal apparatus 201 and the second terminal apparatus 202 may longer than the distance between the first terminal apparatus 201 and the base station 21 if the SBA selects a big angle. Advantages of the present invention will not apparent in these two conditions. Thus, the method of this present invention even more joins a norm condition to order the distance between terminal apparatus and base station and the angle of the sectors. According to the above-mentioned situations, the advantage of promoting efficiency in transmission is achieved by utilizing the method of the present invention, as shown in FIG. 3. The distance between the base station 21 and the first terminal apparatus 201 is R₁, the distance between the base station 21 and the second terminal apparatus 202 is R₂, the distance between the first terminal apparatus 201 and the second terminal apparatus 202 is R₃. From the cosine law:

$${R}_{3}^{2} = {R}_{1}^{2} + {R}_{2}^{2} - 2 {R}_{1} {R}_{2} cos θ \\ ∵ {R}_{2} > {R}_{3} \\ ∴ 2 {R}_{1} {R}_{2} cos θ > {R}_{1}^{2} ⇒ 2 {R}_{2} cos θ > {R}_{1} ⇒ cos θ > \frac{{R}_{1}}{2 {R}_{2}} \\ ∵ {R}_{2} \geq {R}_{1} \\ ∴ if θ < 60 ° ⇒ cos θ > \frac{1}{2} > \frac{{R}_{1}}{2 {R}_{2}}$$

From the point of view of the base station 21, we can transmit a datum by the method of the present invention if the included angle between the first terminal apparatus 201 and the second terminal apparatus 202 is less than 60° (it is known that distance between the first terminal apparatus 201 and the base station 21 is closer than that between the second terminal apparatus 202 and the base station 21).

Before the base station determines whether a datum is desired to transmit to the second terminal apparatus, the following steps will be executed. First, in step S401, the base station broadcasts to request the second terminal apparatus to report a first message to the base station. The first message is used to notice the base station the instant state of the second terminal apparatus so that the base station could use it to determine the sequential steps. The instant state of the second terminal apparatus comprises the power of transmitting a datum of the second terminal apparatus at that time and the position of the second terminal apparatus, etc. However, the above-mentioned embodiment of the present invention is by way of example only, and is not to be construed in a limiting sense. It is to be further understood that numerous changes in the details of the embodiments of the invention will be apparent to, and may be made by, persons of ordinary skill in the art having reference to this description, for example, the first message comprises any information to provide the base station for the further judgement.

After the step S401, the second terminal apparatus start to report the first message to the base station after receiving the broadcast. Meanwhile, the first terminal apparatus actively detect the first message, that is step S402. The first terminal apparatus detects the first message reporting to the base station by the second terminal apparatus at a specific time. The specific time can be adjusted by the base station to notice the first terminal apparatus the time to detect the first message or the first terminal apparatus will decide the time itself to detect the first message. In step S403, the first terminal apparatus reports a second message to the base station according to the first message, and the second message is the data used to help the base station to determine whether the first terminal apparatus and the second terminal apparatus conform to the condition according to the second message.

By executing the aforementioned steps, the base station can find out the conditions of the first terminal apparatus and the second terminal apparatus to determine whether to transmit the datum to the first terminal apparatus or not.

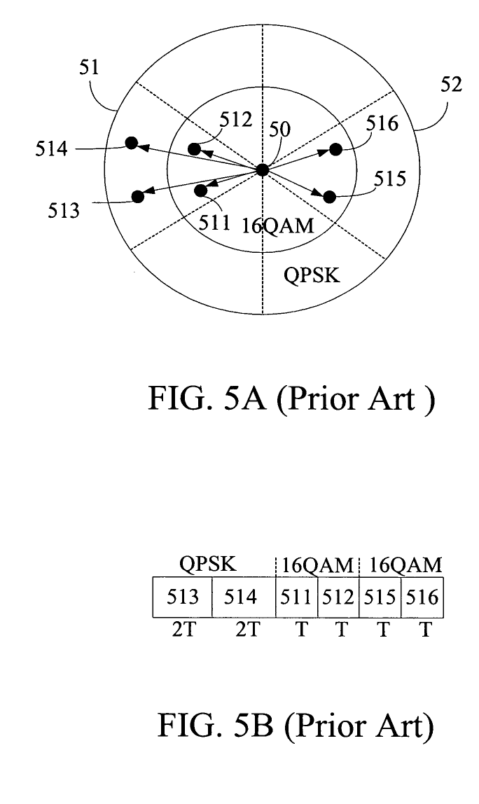

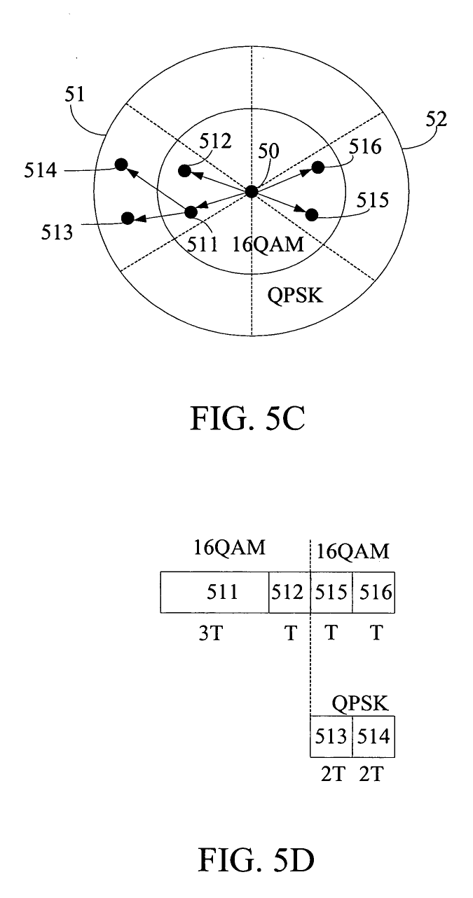

In brief, the difference between the present invention and the prior art will be described by the following embodiments. FIG. 5A and FIG. 5B illustrate the schematic view and the timing diagram, respectively. As shown in FIG. 5A, the modulation of the inner circle is 16QAM, and that of the outer circle is QPSK. As described above, concentric circles are relative to the modulation of each terminal apparatus at the time when executing the method disclosed in the present invention, but it does not mean that the modulation merely relates to the distance. The wireless communication system comprises terminal apparatuses 511, 512, 513, 514, 515 and 516, wherein the modulation of the terminal apparatuses 511, 512, 515 and 516 are 16QAM, and the modulation of the terminal apparatuses 513 and 514 are QPSK. The terminal apparatuses 511, 512, 513 and 514 are located in the fist area 51, and the terminal apparatuses 515 and 516 are located in the second area 52. In the prior art, the base station 50 transmits datum to each terminal apparatuses 511, 512, 513, 514, 515 and 516. As shown in FIG. 5B, it is the timing diagram of transmitting datum of the prior art. The base station 50 transmits datum to the terminal apparatuses 513 and 514 using the QPSK modulation. Each of them will need a period of 2T for transmission. On the other hand, a period of T is needed for transmitting datum to the terminal apparatuses 511 and 512 by means of the 16QAM modulation. The base station 50 service the terminal apparatuses 515 and 516, located in the second area 52, using the 16QAM modulation, and a period of T is necessary. Thus, the total time for transmitting data is 8T.

FIG. 5C and FIG. 5D illustrate the sketch map and the timing diagram of the second embodiment of the present invention respectively. As shown in FIG. 5C, the base station 50 utilizes the terminal apparatus 511, located in the first area 51, to transmit datum to the terminal apparatuses 513 and 514. After the base station 50 sent out the broadcast, the base station 50 transmits a datum to the terminal apparatus 511 using the 16QAM modulation. The datum comprises those data which are desired to transmit to the terminal apparatuses 513 and 514. Because the data quantity that 16QAM can transmit per unit time is larger than QPSK does. Consequently, as shown in FIG. 5D, it only spends an interval of 3T, but not 5T (i.e., 2T+2T+T) as shown in FIG. 5B. After that, the base station 50 transmits datum to the terminal apparatus 512 by 16QAM modulation, and it spends another T. Finally, the base station 50 finished the transmission in the first area 51. The base station 50 serves the terminal apparatuses 515 and 516, located in the second area 52, and spends a period of T for each. When the base station 50 is servicing the terminal apparatuses 515 and 516, the terminal apparatus 511 transmits the datum to the terminal apparatus 513 and 514 by using QPSK modulation, and it spends a period of 2T for each. The base station by utilizing the method of the present invention merely spent an interval of 6T, which is less than the time of 8T of the prior art. Apparently, the present invention may reduce the transmission time as compared with the prior art.

The above disclosures are related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for a wireless communication system, the wireless communication system comprising a base station, a first terminal apparatus and a second terminal apparatus, the method comprising:
transmitting a first datum to the first terminal apparatus by the base station when the base station desires to transmit the first datum to the second terminal apparatus, the first terminal apparatus and the second terminal apparatus conform to a condition, and the condition is a first time shorter than a second time, wherein the second time is the time the base station transmitting the first datum to the second terminal apparatus and the first time is the time the base station transmitting the first datum to the first terminal apparatus plus the time the first terminal apparatus transmitting the first datum to the second terminal apparatus; and
requesting the first terminal apparatus transmitting the first datum to the second terminal apparatus by the base station.

2. The method according to claim 1, further comprising:
transmitting the first datum to the second terminal apparatus by the base station when the first terminal apparatus and the second terminal apparatus do not conform to the condition.

3. The method according to claim 2, wherein the base station comprises an antenna, defining a plurality of areas, comprising a first area and a second area, and the first terminal apparatus and the second terminal apparatus are located in the first area.

4. The method according to claim 3, wherein the wireless communication system further comprises a third terminal apparatus, being located in the second area, and the base station transmits a second datum to the third terminal apparatus in the second area after the base station requests the first terminal apparatus to transmit the first datum to the second terminal apparatus.

5. The method according to claim 3, wherein the antenna is a switched beam antenna (SBA).

6. The method according to claim 1, wherein the condition further comprises:
the base station determining the first terminal apparatus having a better modulation than that of the second terminal apparatus, and the modulation being the bits that the first terminal apparatus and the second terminal apparatus can receive per symbol (bits/symbol) when the base station transmits the first datum to the first terminal apparatus and the second terminal apparatus.

7. The method according to claim 1, wherein the condition further comprises:
the base station determining the first terminal apparatus being able to return bigger power to the base station than the second terminal apparatus.

8. The method according to claim 1, further comprising:
requesting the second terminal apparatus to report a first message to the base station, wherein the first message is used to notice the base station the status of the second terminal apparatus.

9. The method according to claim 8, further comprising the following step before reporting the first message to the base station:
detecting the first message by the first terminal apparatus at a particular time; and
reporting a second message to the base station according to the first message by the first terminal apparatus, wherein the base station determines whether the first terminal apparatus and the second terminal apparatus conform to the condition according to the second message.

10. The method according to claim 9, wherein the particular time is determined by the base station.

11. The method according to claim 9, wherein the particular time is determined by the first terminal apparatus.

12. A communication system, comprising:
a plurality of terminal apparatuses for receiving a first datum, wherein the plurality of terminal apparatuses comprise a first terminal apparatus and a second terminal apparatus; and
a base station for transmitting the first datum to the first terminal apparatus and determining when the base station desires to transmit the first datum to the second terminal apparatus, and the first terminal apparatus and the second terminal apparatus conform to a condition, and the condition is a first time shorter than a second time, wherein the second time is the time the base station transmitting the first datum to the second terminal apparatus and the first time is the time the base station transmitting the first datum to the first terminal apparatus plus the time the first terminal apparatus transmitting the first datum to the second terminal apparatus, and requesting the first terminal apparatus transmitting the first datum to the second terminal apparatus by the base station.

13. The communication system according to claim 12, wherein the base station determines when the first terminal apparatus and the second terminal apparatus do not conform to the condition, the base station transmits the first datum to the second terminal apparatus.

14. The communication system according to claim 12, wherein the base station further comprises an antenna, defining a plurality of areas, comprising a first area and a second area, and the first terminal apparatus and the second terminal apparatus are located in the first area.

15. The communication system according to claim 14, wherein the base station further comprises at least a third terminal apparatus, being located in the second area, and the base station transmits a second datum to the third terminal apparatus in the second area after the base station requested the first terminal apparatus to transmit the first datum to the second terminal apparatus.

16. The communication system according to claim 14, wherein the antenna is a switched beam antenna (SBA).

17. The communication system according to claim 12, wherein the condition further comprises the base station determines whether the second terminal apparatus has a better modulation than the first terminal apparatus, and the modulation relates to the bits that the first terminal apparatus and the second terminal apparatus can receive per symbol (bits/symbol) when the base station transmits the first datum to the first terminal apparatus and the second terminal apparatus.

18. The communication system according to claim 12, wherein the condition further comprises the base station determines the first terminal apparatus can return bigger power to the base station than the second terminal apparatus does.

19. The communication system according to claim 12, wherein the base station further comprises requests the second terminal apparatus to report a first message to the base station, and the first message is used to notice the base station the status of the second terminal apparatus.

20. The communication system according to claim 19, wherein the first terminal apparatus detects the first message at a particular time before the second terminal apparatus reports the first message to the base station, and the first terminal apparatus reports a second message to the base station according to the first message, wherein the base station determines whether the first terminal apparatus and the second terminal apparatus conform to the condition according to the second message.

21. The communication system according to claim 20, wherein the particular time is adjusted by the base station.

22. The communication system according to claim 20, wherein the particular time is adjusted by the first terminal apparatus.
